(19) United States
(12) Patent Application Publication
(10) Pub. No.: US 2004/0259064 A1
(43) Pub. Date: Dec. 23, 2004

(54) Personal continuing education kit for dentist and method of use therefore

(76) Inventor: Paul C. Belvedere, Edina, MN (US)

Correspondence Address: BRIGGS AND MORGAN, P.A., 2200 IDS CENTER, MINNEAPOLIS, MN, 55402, US

(21) Appl. No.: 10/756,555

(22) Filed: Jan. 13, 2004

Related U.S. Application Data
(60) Provisional application No. 60/441,036, filed on Jan. 13, 2003.

(51) Int. Cl. G09B 23/28

(52) U.S. Cl. 434/263

(57) ABSTRACT

The personal continuing dental education kit includes the printed information, instructions and workbook materials relevant to the use of the Kit outlining and explaining the components of the kit, the teaching materials for the transmission of information needed by the participant to understand the procedures necessary to accomplish the goals of the kit, visual demonstration materials, through pictures, drawings, illustrations, and/or analog or digital electronic media presentations, through CD-Rom, DVD, or Video Tape, a model of a dental arch with teeth, the filling materials, the specialized instruments to perform the procedure on the model of the dental arch and a self-assessment test.

### BACKGROUND OF INVENTION

This application is a continuation in part of application Ser. No. 60/441,036 filed on Jan. 13, 2003.

The invention relates to continuing education for professionals, and more particularly to a personal continuing dental educational kit.

There are substantial cost and time requirements for professional individuals to maintain their obligation for the fulfillment of continuing education regulations in the maintenance of licensure and/or academic standing in their profession. Currently continuing education is conducted in class rooms, hotels and in labs away from the work setting. Consequently, considerable time away from work, office or clinic is required.

Cost and time requirement also applies to the learning of new techniques, methods and the use of advanced materials and manner of accomplishing goals for improvement of their professional skills and to serve their patients, and/or clients so that they will benefit through efficiencies that can he gained with contemporary developments.

More specifically in dentistry the established method of teaching new and/or advanced techniques has been through the bringing together of teacher and student in various venues, i.e., dental schools, convention centers, hotels rooms, and dental offices, to name a few.

Presently there are various avenues of “at-home learning” available to dentists and dental teams. They are all one or two dimensional, i.e. audio, reading text, or watching, or combinations of these. None are three dimensional, i.e., the telling, the showing and then the doing on dental models with prepared teeth.

There is a need to supply a Kit of materials to permit a participant to learn, feel, and accomplish a restorative dental procedure in a private setting of the participants choosing rather than traveling to, joining into, or being forced to be present in a structured venue. The participant, at his/her own time and place, will; read, listen to, or watch, the step-by step procedure in order to facilitate the goals set out in the PCE course for accomplishment of a specific dental restorative procedure.

### SUMMARY OF THE INVENTION

The personal continuing dental education kit includes the printed information, instructions and workbook materials relevant to the use of the Kit outlining and explaining the components of the kit, the teaching materials for the transmission of information needed by the participant to understand the procedures necessary to accomplish the goals of the kit, visual demonstration materials, through pictures, drawings, illustrations, and/or analog or digital electronic media presentations, through CD-Rom, DVD, or Video Tape, a model of a dental arch with teeth, the filling materials, the specialized instruments to perform the procedure on the model of the dental arch and a self-assessment test.

A principal object and advantage of the present invention is to bring continuing education to participants rather than bringing participants to continuing education. Through the addition of dental models, instruments and materials for the first time in continuing dental education, this concept has never been done.

Another object and advantage includes in certain instances that the kit will not be strictly for continuing education requirements. The information and increased confidence in performing new procedures is justification alone for using this kit concept.

Another object and advantage is that the kit is three dimensional, i.e., the telling, the showing and then the doing on dental models with teeth in that it supplies all of the essentials: the information in printed form, on video, DVD, or CD-Rom, the dental model with prepared teeth, the filling materials, and the instruments.

Another object and advantage is that the kit enables the more efficient achievement of the teaching goal, which is to inform then show, and then have the participants accomplish a procedure, all at home or in a quite work environment.

Another object and advantage is by supplying a complete kit of learning materials, it will allow the student or participant the opportunity to mentally and physically learn-and-do at a place of the student's choosing other than a structured venue or teaching facility, and at a pace best suited for the individual. It will expand the continuing education availabilities to many more recipients than can be presently accommodated and can be available world-wide.

### BRIEF DESCRIPTION OF THE DRAWINGS

FIG. 1 is a schematic of the components of the kit and method of use of the present invention.

### DETAILED SPECIFICATION

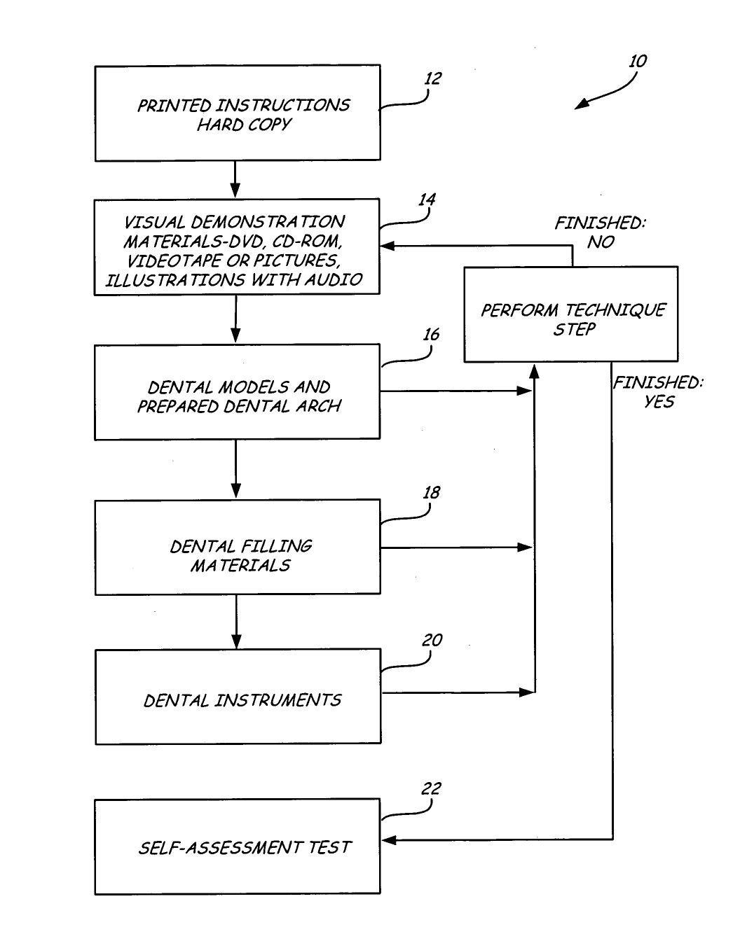

Referring to FIG. 1, the invention in its broadest sense includes a personal dental education kit 10 including printed instructions 12, audio visual demonstration materials 14, dental models 16, dental filling materials 18, dental instruments 20 and a self-assessment test 22.

The printed materials 12 are a hard copy of instructions which may be in the form of a booklet, paper, workbook or the like. The purpose of the printed materials is to fully explain to the dental practitioner what is included in the kit 10, how to use the kit and the steps for use of the kit 10 to accomplish the discipline to gain the most knowledge.

The visual demonstration materials 14 suitably would include some form of audiovisual, such as DVD, CD-ROM or video tape which may be played so that the visual demonstration 14 may be seen in action. Alternatively, should an audiovisual player not be available, the kit 12 may include other visual demonstration materials 14, such as illustrations or pictures with audio to be played by a player. The visual demonstration materials 14 show the dental problem with an actual human dentition showing the problem teeth, or tooth or may simply show a model. Next the demonstration materials 14 show the preparation of the teeth or tooth which includes the creation of openings that are placed by dentists in a tooth or teeth to create a place for the filling material to reproduce and restore the shape and function of the tooth or teeth. Next the visual demonstration material 14 would identify the dental filling material 18 and dental instruments 20 and the steps to be taken for the dental restorative procedure.

Ideally, the visual demonstration materials 14 will be arranged in such a manner so that the dental participant will be coached to follow the step-by-step directions until accomplishing one specific portion of the specific technique. That is, the participant will be instructed to pause the visual demonstration materials 14 during viewing and/or reading until such time that the participant has accomplished that portion of the instructions to that point. Thereafter, the visual demonstration may be started again.

The dental models 16, suitably may be man-made dental arches that replicate the human dentition with plastic teeth. The models 16 may show the dental problem in real life fashion ready for preparation and restoration. Additional models 16 may be included in the kit 10 which show the teeth or tooth prepared suitably by cutting away in preparation for the dental restorative procedure. Dental models 16 may also include a fully restored dentition showing the teeth or tooth after the procedure so that the dental participant can see the goal to be accomplished. The dental model 16 may also include working models to be prepared by the participant and thereafter to receive the dental restorative procedure.

The dental filling material 18 generally include tooth colored resin-based composites composed of Bis, glass fillers, contours strips, veneers, posts and crowns. The dental filling materials 18 are used to fill the voids at are created in the prepared dentition to complete the dental restorative procedure.

The dental instruments 20 include hand held tools for using, control, placement and shaping of dental filling materials 18 and may also include matrices which are strips of thin plastic or metal placed around the external portion of the human tooth for the purposes of confining dental restorative materials 18 being placed in the preparations.

The self-assessment test 22 is a self-elevation test wherein the questions may be in the form of true of false and/or multiple choice. The answers to the questions may be found in the teaching materials including the printed instructions 12 and the visual demonstration materials 14. The test 22 may be necessary for maintaining licesensure and/or academic standing. The test 22 may include a return envelope to ensure acceptance by the governing bodies of a non-participant graded test after which a grade may be returned to the dental participant.

An example of a test 22 questions may be as follows:

The matrix band can be held into position.

_By bond resin

_By contact pressure

_By the dentist fingers

_All of the above

The personal dental education kit 10 may be used to teach the use of the contours strip for class III, class IV and class V of direct vencers; fiber reinforced direct composite bridges showing the procedure to create directly placed fixed tooth replacements for adolescence and/or geriatric problem solving; direct placement of posterior composite restoration with tight contacts including various techniques for the placement of direct posterior composite restorations for the replacement of Amalgam fillings; direct composite veneers; and creating a fiber reinforced post and a creation of a full crown, utilizing construct, ribbond or glasspan for the creation of the reinforcing post when a direct crown is to be fabricated suitably in geriatric problem-solving.

Referring to FIG. 1, the method of use of the personal dental education kit 10 may be appreciated. The dental participant opens up the kit 10 and reviews the printed instructions in their hard copy 12. Next the dental participant starts the visual demonstration materials 14 to review various steps in the procedure and stopping the visual materials 14 at each step. Next the dental participant studies the dental models. Perhaps the next suitable step would include the preparation of the dental arch models 16 using the dental instruments 20. Suitably the visual demonstration materials 14 would be restarted to the next step which would be the beginning of the dental restorative procedure utilizing the dental filling materials 18 and dental instruments 20 on the prepared dental models 16. This cycle will continue the until the dental restorative procedure is finished. Then dental participant will proceed to the self-assessment test 22 after which it will be mailed away in the returned envelope for grading and the return of a grade to the dental participant.

It should be appreciate that the personal dental educational kit 10 may be repeatedly used with the dental models 16 and visual demonstration materials 14, dental filling materials 18 and dental instruments 20 so that the participant can perfect to his/her satisfaction the dental restorative procedure.

The present invention may be embodied in other specific forms with out departing from the spirit or essential attributes thereof, and it is therefore that the present invention be considered in all aspects as illustrative and not restrictive, reference being made to the appended claims rather than to the forgoing description to indicate the scope of the invention.

What is claimed:

1. A personal dental education kit for teaching new and advanced dental preparation and restorative procedures, comprising:
(a) a hard copy of printed instructions on how to use the kit and steps to accomplish discipline in the advanced dental procedures;
(b) audiovisual demonstration materials showing an actual dentition problem, procedures for preparation of the dentition and procedures for the dentition restoration;
(c) a dental model of the problem dentition for the preparation and restorative procedures;
(d) a dental filling material for the restorative procedure on the prepared dentition; and
(e) dental instruments for placement, control and shaping of the dental filling material in the restorative procedure.

2. The apparatus of claim 1, further comprising a self-evaluation test for fulfilling licensure and academic standing.

3. The apparatus of claim 1, wherein the audiovisual demonstration materials are chosen from a group comprising audiovisual, DVD, CD-ROM, videotape, pictures, illustrations and audio.

4. The apparatus of claim 1, further comprising a second model of prepared dentition.

5. The apparatus of claim 4, further comprising a third model of restored dentition.

6. A personal dental education kit for teaching new and advanced dental preparation and restorative procedures, comprising:
(a) a hard copy of printed instructions on how to use the kit and steps to accomplish discipline in the advanced dental procedures;
(b) audiovisual demonstration materials showing an actual dentition problem, procedures for preparation of the dentition and procedures for the dentition restoration;
(c) a dental model of the problem dentition for the preparation and restorative procedures;
(d) a dental filling material for the restorative procedure on the prepared dentition;
(e) dental instruments for placement, control and shaping of the dental filling material in the restorative procedure; and
(f) a self-evaluation test for fulfilling licensure and academic standing.

7. The apparatus of claim 6, wherein the audiovisual demonstration materials are chosen from a group comprising audiovisual, DVD, CD-ROM, videotape, pictures, illustrations and audio.

8. The apparatus of claim 6, further comprising a second model of prepared dentition.

9. The apparatus of claim 8, further comprising a third model of restored dentition.

10. A method for personal dental education for teaching new and advanced dental preparation and restorative procedures with a kit including printed instructions, audiovisual demonstration materials, a dental model, a dental filling material, dental instruments and a self-evaluation test, the method comprising:
(a) reviewing the printed instructions;
(b) intermittently watching the audiovisual materials in steps;
(c) performing the preparation procedure step on the dental model;
(d) performing the restoration procedure step on the prepared dental model; and
(e) taking the self-evaluation test.
